(19) United States
(12) Patent Application Publication
(10) Pub. No.: US 2011/0320373 A1
(43) Pub. Date: Dec. 29, 2011

(54) PRODUCT CONVERSATIONS AMONG SOCIAL GROUPS

(75) Inventors: Min-John Lee, Santa Cruz, CA (US); David James Gemmell, Danville, CA (US); Ashok K. Chandra, Saratoga, CA (US); Vincent Vergonjeanne, Paris (FR)

(73) Assignee: Microsoft Corporation, Redmond, WA (US)

(21) Appl. No.: 12/823,550

(22) Filed: Jun. 25, 2010

(51) Int. Cl. G06Q 99/00; G06Q 30/00; G06F 3/00

(52) U.S. Cl. 705/319; 715/758

(57) ABSTRACT

Conversations about products and product areas arise among users who also participate in social networks. These conversations often occur over generalized communications channels, such as email or social network messages, which may be unstructured and ephemeral. Such conversations may be promoted among the users of a social group (such as a highly interconnected set of users), and may be restricted to the members of the social group in order to promote reliable discussion and personalized recommendations. The social network may also store such conversations as a product review database that is searchable by members of the social group, evaluate the conversation to identify a consensus recommendation of a product in a product area or a consensus opinion of the social group about a product or recommendation, and compute an aggregated user rating of a product based on the user ratings of the product by various members of the social group.

### BACKGROUND

Within the field of computing, many scenarios involve aspects of social networking, wherein users may establish associations representing relationships with other users, and may share data of interest with all or some associated users. In this context, a user may establish a social profile comprising data that identifies various aspects of the user to associated users, such as demographic information, a set of interests such as hobbies or professional skills, and a set of resources that are interesting to the user. Users may consent to having some aspects of his or her social profile shared; e.g., a user might author a message (such as a personal status, a note about a particular topic, or a message directed to another user) that may initially be accessible only to users who are associated with the user, but may permit an associated user to repost the message for access by all of the users associated with the associated user (e.g., a friend of a user may be permitted to take the user's message and repost it to grant access to the friend's friends.) In this manner, data shared over a social network (and, in particular, data comprising the social profile of a user) may be propagated in select ways to others via the social network.

Also within the field of computing, many scenarios involve a discussion among a set of users about a product (including a manufactured, cultivated, or discovered article or composition of matter, a media item such as a movie, or a tangible or intangible service.) The discussion may also be initiated in many ways (e.g., a user review of a product or a request for such a review, a request for a product recommendation of a product in a particular product area, or a comparison of two or more products in a particular product area), and the comments of the discussion may comprise questions, answers, ideas, comparisons, qualitative opinions, and/or quantitative ratings of particular aspects of one or more products. The conversation about the product(s) may also be shared publicly, e.g., by incorporation in a database of product reviews in a reviews website, or may be restricted to particular users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While many computing scenarios may permit a conversation among two or more users about one or more products, many scenarios may appear to be comparatively impersonal. For example, a user may wish to initiate or participate in a discussion of a product, but the other participants in the conversation may be unknown to the user, and may not be able to provide information in view of the particular details of the user. Additionally, the user may be unable to evaluate the reliability of the opinions expressed by the other participants, some of whom may have a biased opinion and/or an interest in skewing the discussion in a particular direction, such as employees of one or more vendors of the products being discussed. Therefore, it may be difficult to obtain information about the products of interest that is personalized for use by the user.

In order to achieve personalized information about a product (such as personalized product recommendations), a user may utilize a social network, e.g., by posting a message viewable by associated users of the user that inquires about a particular product or product area. Associated users who have an association with the user may reply with personalized information about the products, and are more likely to have an interest in providing reliable and accurate information to the user (e.g., in order to preserve the association of the associated user with the user.) In many scenarios, this conversation may utilize the ordinary communications channels of the social network, such as the posting of status messages that together comprise a conversation, or the exchange of private email messages. However, the social network is likely to treat such conversations similarly to conversations about any topic, e.g., as a trivial discussion with only ephemeral value that may be safely discarded after user interest in the discussion wanes. The social network may fail to identify, store, or use the semantics of the conversation in any way.

It may be advantageous to configure the social network to handle conversations about products among the users of a social group in a different and more significant manner than conversations about other topics. As a first example, it may be possible to identify significant information in the comments of a conversation about one or more products, e.g., user opinions or ratings of a product, comparisons of different products, and recommendations of various products in a product area. This information may be compiled to describe the respective products and the product area, and may be stored as a product review data set that users within the social group may examine (possibly at a much later date) to receive relevant information about products in various product areas. These conversations are generated by associated users who are known and trusted by the user, and the associated users may provide information specifically for the user, thereby improving the relevance and personalization of the product information to the user. Moreover, the conversations are restricted to the users of the social group, and are thus kept semi-private, such that users may communicate candidly about the products. As a second example, the social network may facilitate the conversation by inferring structure among the comments (e.g., consolidating all of the comments regarding a particular product, aggregating a set of qualitative or quantitative user ratings of a product into an aggregated user rating for the social group, or inferring a product recommendation of a product by the social group among the comments submitted by the users of the social group), and by prompting users to contribute (e.g., inviting a user of a social group to contribute a product recommendation in a product area or notifying a user of new information in the conversation posted by another user.) These and other techniques may be implemented to utilize the features of the social network to facilitate the conversation of the products by the users of the social group.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring conversations about products among users of a social network.

FIG. 2 is an illustration of an exemplary scenario featuring a social network configured to manage conversations about products among the users of the social network in accordance with the techniques presented herein.

FIG. 3 is an illustration of an exemplary scenario featuring a conversation store configured to receive comments and store conversations about various products by users of social groups in a social network in accordance with the techniques presented herein.

FIG. 4 is an illustration of an exemplary scenario featuring a conversation store configured to present conversations about various products by users of social groups in a social network in accordance with the techniques presented herein.

FIG. 5 is a flow chart illustrating an exemplary method of presenting a conversation about a product among users of a social group in a social network in accordance with the techniques presented herein.

FIG. 6 is a component block diagram illustrating an exemplary system for presenting a conversation about a product among users of a social group in a social network in accordance with the techniques presented herein.

FIG. 7 is an illustration of an exemplary computer-readable medium comprising processor-executable instructions configured to embody one or more of the provisions set forth herein.

FIG. 8 is an illustration of an exemplary scenario featuring an initiation of a conversation about a product for a social group in response to a search query for the product submitted by a user of the social group.

FIG. 9 is an illustration of an exemplary scenario featuring an exemplary presentation to a user of a social group comprising conversations about various products.

FIG. 10 is an illustration of an exemplary scenario featuring another exemplary presentation to a user of a social group comprising conversations about various products.

FIG. 11 is an illustration of an exemplary scenario featuring yet another exemplary presentation to a user of a social group comprising conversations about various products.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a social network, comprising a set of users who may establish associations thereamong (representing various types of relationships, e.g., familial, friendship, acquaintanceship, academic, and professional), and who may share data items with other users or social groups of users. Many such scenarios permit a user to post a message (such as a personal status) that may be readable by all associated users who have an association with the user, and such associated users may reply to the message in a manner that is readable by all of the other associated users. Users of a social network may also generate a social profile, comprising a set of data items representing the user, such as demographic information, a set of interests such as hobbies or professional skills, and a set of resources that are interesting to the user. These data items may be shared through the social network with associated users who have an association with the user.

Also within the field of computing, many scenarios may involve a conversation among a set of users of one or more products, such as a manufactured, cultivated, or discovered article or composition of matter, a media item such as a movie, or a tangible or intangible service. The conversation may focus on quality aspects of the product, and may involve user reviews and/or user ratings of the product. The conversation may also be initiated, e.g., by a user posting a comment about a product or requesting information about a product. The conversation may also focus on more than one product, e.g., a comparison of two or more products in a particular product area, which may be initiated by a request by a user for a product recommendation of a product in the product area.

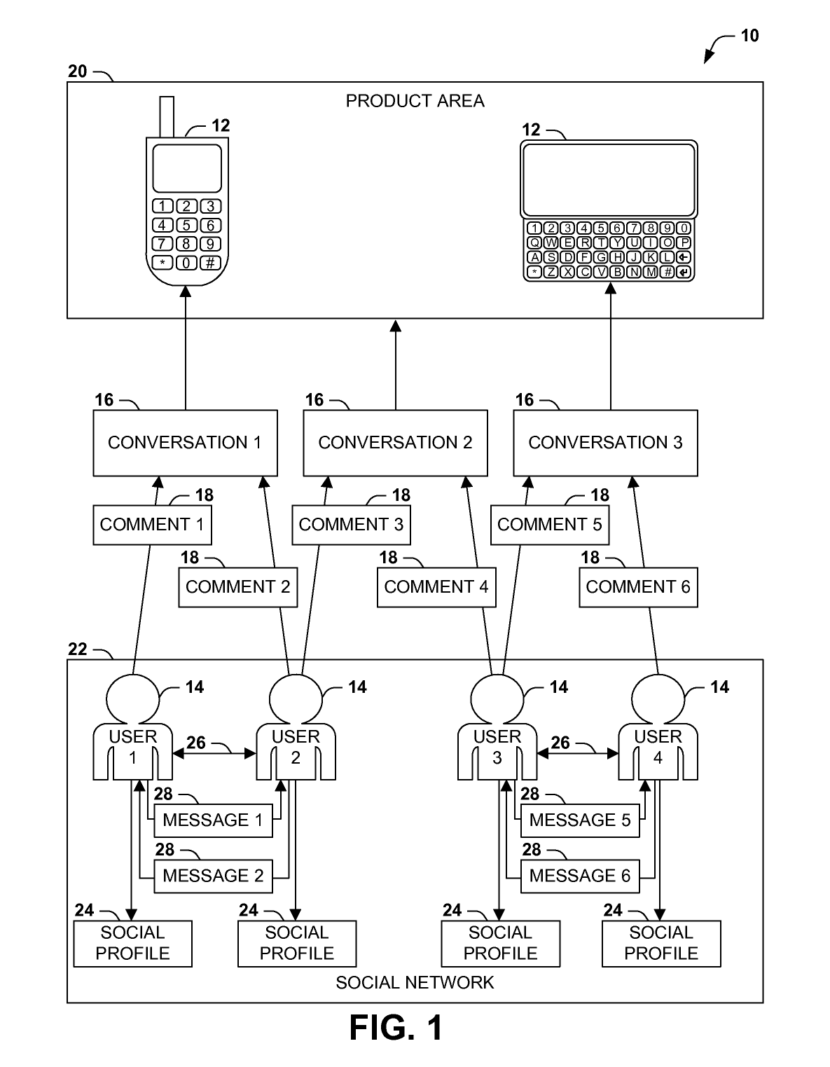

FIG. 1 presents an exemplary scenario 10 featuring users engaging other users in both contexts. In this exemplary scenario 10, a set of products 12 is discussed by a set of users 14, each of which may participate in one or more conversations 16 relating thereto. For example, a first conversation 16 may relate to a first product 12, and a third conversation 16 may relate to a second product 12, while a second conversation 16 may solicit comparative reviews of several products 12 within a particular product area 20 (e.g., mobile communication devices, such as a mobile phone and a text messaging device.) The conversations 16 may involve various comments 18 submitted by the users 14 and relating to the products 20 involved in each conversation 16. These comments 18 may be exchanged through many communications mechanisms (e.g., email, instant messaging, a web forum, a weblog, or a set of messages exchanged in a social network.) The conversations 16 may also be publicly accessible, or may be restricted to a particular set of users 14 (e.g., a conversation 16 arising through an email list.) For example, a first conversation 16 may involve a first set of comments 18 pertaining to the first product 12 as the topic of the first conversation 16; a third conversation 16 may involve a third set of comments 18 pertaining to the third product 12 as the topic of the third conversation 16; and a second conversation 16 may pertain to several products within a defined product area 20, and a second set of comments 18 relating thereto.

As further illustrated in this exemplary scenario 10, respective users 14 also participate in a social network 22, wherein each user 14 may generate a social profile 24 describing the user 14, and may establish one or more associations 26 with other users 14. Users 14 who have an association 26 may exchange messages 28, and depending on the nature of the respective messages 28, a message may be viewable only by the sender and recipient; by the sender, the recipient, and some or all of the other users who have an association 26 with the sender and/or the recipient; or by anyone who wishes to view the messages 28. By connecting the users 14 in this manner, the social network 22 may facilitate communication and the sharing of data among users 14 based on the associations established thereamong.

The exemplary scenario 10 of FIG. 1 therefore illustrates users 14 who are members of a social network 22 who are also participants in conversations 16 about various products 12. However, this exemplary scenario 10 illustrates some limitations of these models of communication. As a first example, if the conversations 16 occur in a manner that is dissociated with the social network 22, the conversations 16 may be comparatively impersonal or anonymous. For example, the second conversation 16 about the product area 20 arises between a second user 14 and a third user 14, but these users 14 have no association 26 with other users 14 of the social network 22, and may be completely unknown to each other. Therefore, each user 14 may have difficulty receiving from the other user 14 information that is personalized in view of the circumstances and interests of the user 14. As a second example, each user 14 may be unable to ascertain the reliability or credibility of the other user(s) 14 participating in a conversation 16. For example, in the second conversation 16, the second user 14 may be inadequately or incorrectly informed about the product area 20 and may provide inaccurate information to the third user 14, or may have a biased viewpoint (e.g., as a representative of a vendor of a product 12 included in the conversation 16) and may intentionally mislead the conversation 16. Each user 14 participating in a conversation 16 may have difficulty determining the reliability and trustworthiness of other users 14 participating in the conversation 16.

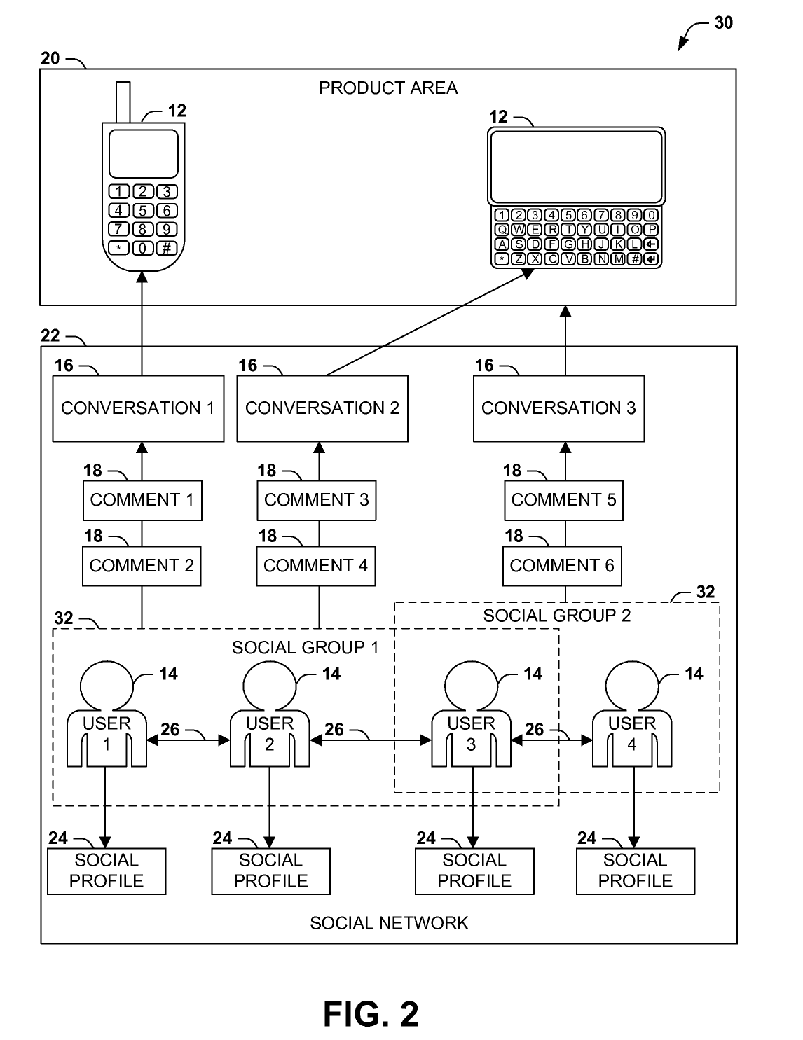

An improvement of this conversation model may be achieved by holding the conversations 16 among the users 14 of the social network 22. FIG. 2 presents an exemplary scenario 30 featuring an overview of this conversation model, wherein the users 14 of a social network 22 hold conversations 16 about two products 12 within a product area 20 (specifically, the product area 20 of mobile communication devices, and two particular products 12 in this product area 20.) However, in contrast with the exemplary scenario 10 of FIG. 1, conversations 16 about various products 12 among the users 14 of the social network 22 are restricted to the social groups 32 of the users 14. For example, a first social group 32 may be identified as a set of users 14 who share associations 26 (e.g., either a tightly interconnected set of users 14 from a particular context, such as a social clique or the students in a class in an academic setting, or as a particular user 14 and the other users 14 who have associations 26 with the particular user 14.) Respective social groups 32 may hold conversations 16 about one or more products 12, but the conversations 16 may be accessible only to the users 14 within the social group 32. For example, a first social group 32 (comprising a first user 14, a second user 14, and a third user 14) may initiate a first conversation 16 about a first product 12 in a product area 20, involving a first comment 18 and a second comment 18, and a second conversation 16 about a second product 12 in the same product area 20, involving a third comment 18 and a fourth comment 18. Similarly, a second social group 32 (comprising the third user 14 and a fourth user 14) may initiate a third conversation 16 about all of the products 12 in the product area 20, comprising a fifth comment 18 and a sixth comment 18. The first user 14 and the second user 14, as members of the first social group 32, may access the comments 18 of the first conversation 16 and the second conversation 16, but may not access the comments 18 of the third conversation 18, since these users 14 are not within the social group 32 of the third conversation 16. However, the third user 14, as a member of both the first social group 32 and the second social group 32, may access the comments 18 of all three conversations 16. In this manner, the associations 26 established among the users 14 of the social network 24 may promote the privacy of the conversations 16 among the users 14 of a social group 32, as well as the reliability and relevance of the comments 18, since the users 14 of a social group 32 may know and trust each other, and may be able to provide comments 18 that are personalized for the other users 14 of the social group 32.

In view of these considerations, a small improvement in the exemplary scenario 10 of FIG. 1 may be achieved by holding the conversation 16 using the messaging system of the social network 22, e.g., by sending the comments 18 regarding the products 12 to other users 14 as messages 28. This improvement may promote the privacy of the conversation 16 among the users 14, e.g., by restricting access to the messages 28 to the users 14 who have associations 26 with at least one of the users 14, and may also promote the reliability of the conversation 16. However, in this variation, the social network 22 handles the comments 18 of the conversations 16 similarly to any other message 28. As a first example, many types of messages 28 exchanged within the messaging systems of social networks 22 (such as personal status messages) are regarded as of ephemeral value, and are not often retained by the social network 22 for a significant period of time. For example, the social network 22 may retain a message 28 only for a short period of time or as long as the users 14 continue to view and interact with a message 28 (e.g., by posting a reply), and may then discard the message 28. Indeed, in view of the volume of messages 28 exchanged across a social network 22, endeavoring to retain all messages 28 may cause difficulties with scalability. As a second example, many social networks 22 do not permit searching of messages 28, or may restrict such searching to recently generated messages 28. Therefore, a user 14 may be unable to retrieve via searching the comments 18 of a conversation 16 about a product 12 that occurred last year. Moreover, the social network 22 might offer a search feature based on keywords, and it may be difficult to search for a product 12 identified by a non-distinctive name. As a third example, the messages 28 of a social network 22 have little structure. For example, the social network 22 may be able to display the messages 28 in chronological order or sorted by author. However, the social network 22 may be unable to present the messages 28 in view of the responsive relationships thereamong (e.g., as a threaded discussion), to identify all messages 28 relating to a particular product 12 (including those that are part of the conversation 16 but that do not include the name of the product 12), or to summarize a conversation 16, e.g., as a set of user reviews of various products 12 by different users 14, as a set of user ratings of the products 12, or to indicate a conclusion of the conversation 16, such as recommendation, such as an aggregated user rating of the product 12 of the conversation 16 (e.g., an average of all user ratings of all users 14 in the conversation 16) or a product recommendation of a product 12 In a product area 20 regarding which the users 14 have reached a consensus. In these and other ways, the ordinary messaging system of the social network 22 may be inadequate for holding conversations 16 among users 14 about various products 12.

Presented herein are techniques for configuring a social network 22 to promote conversations 16 among users 14 of products 12. According to these techniques, a conversation 16 about one or more products 12 may be initiated by the users 14 of a particular social group 32, such as a user 14 initiating the conversation 16 and all of the associated users who have an association 26 with the user 14. The user 14 may initiate the conversation 16 in many ways, e.g., by requesting a user review of a particular product 12, by creating a user review of a particular product 12, by requesting a product recommendation of a product 12 within a product area 20, or by comparing products 12 within a product area 20. The social network 22 may identify that the conversation 16 is about a particular product 12, and that no conversation 16 about the product 12 or product area 20 currently exists for the social group 32 including the user 14, and may therefore create a record for the conversation 16 in a conversation store (e.g., a storage device, such as a hard disk drive, or a storage structure, such as a database, that is configured to store the comments 18 of conversations 16 about various products 12.) Comments 18 submitted by various users 14 as part of the conversation 16 may then be stored in the conversation store. Additional evaluation may be performed to evaluate the structure and direction of the conversation 16, e.g., to generate a summary of the conversation 16 (such as a consensus user review of the product 12 or a consensus recommendation of a product 12 in the product area 20.) Additionally, when a user 14 of the social network 22 submits a search query about a product 14 or product area 20, the social network 22 may search the conversation store, retrieve any conversations 16 about the product 14 or product area 20 within the social group 32 of the user 14, and present the conversations 16 to the user 14.

These techniques may present some advantages over the use of an unstructured conversation 16 about such products 12, such as a conversation 16 via email, instant messaging, or the ordinary messaging system of the social network 22. As a first example, these techniques may promote the organization of such conversations 16 by consolidating all comments 18 about a particular product 12 among the users 14 of a social group 32 within one conversation 16, and may also facilitate an identification and consolidation of the structure of the conversation 16 (e.g., the responsiveness of particular comments 18 to other comments 18, such as a threaded conversation.) As a second example, the consolidation imparted by these techniques may promote the discoverability of the conversation 16 by the users 14 of the social group 32, e.g., as a searchable database of user reviews of products 12. As a third example, these techniques may promote the evaluation of the conversation 16, such as the determination of a consensus achieved by the social group 32 of the quality of a product 12 or of a consensus recommendation of a product 12 within a product area 20. Other features may also be introduced by storing the conversations 16 in this manner; e.g., by identifying when users 14 take particular consumer actions (such as deciding to purchase a particular product 12 over another product 12) and why the user 14 chose these consumer actions (e.g., as may be identifiable from the comments 18 of a conversation 16), it may be possible to detect the influence of a particular user 14 on the decisions of other users 14 within a social group 32.

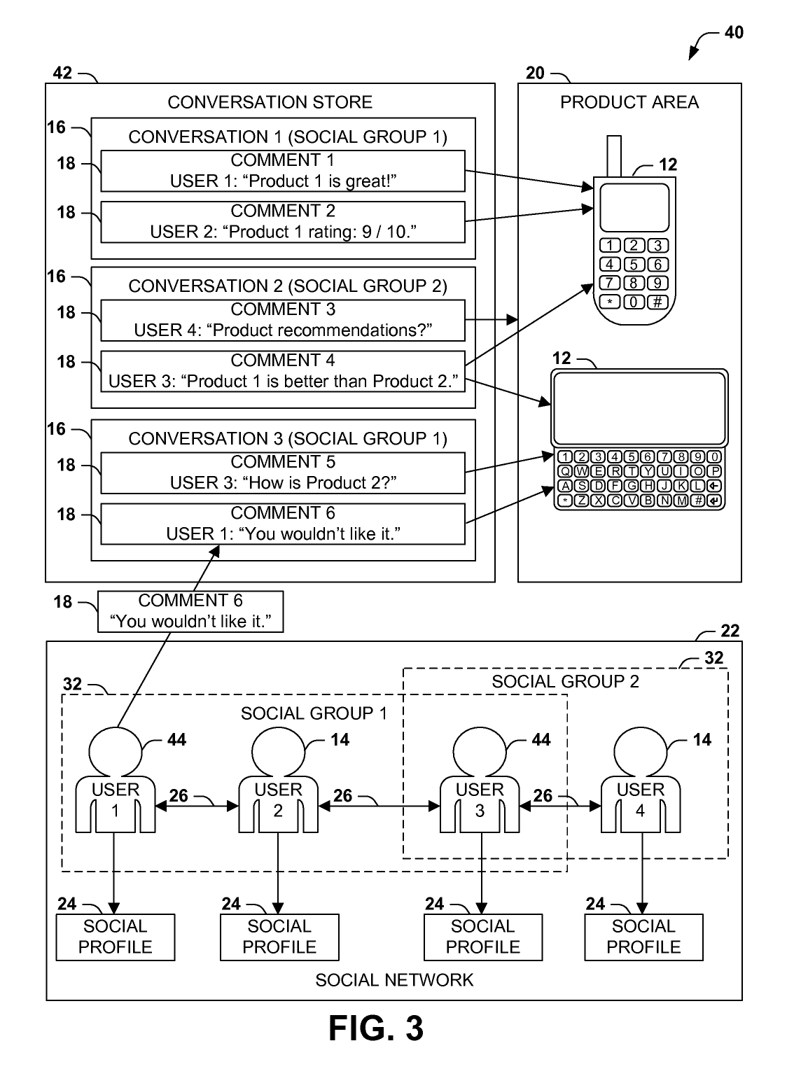

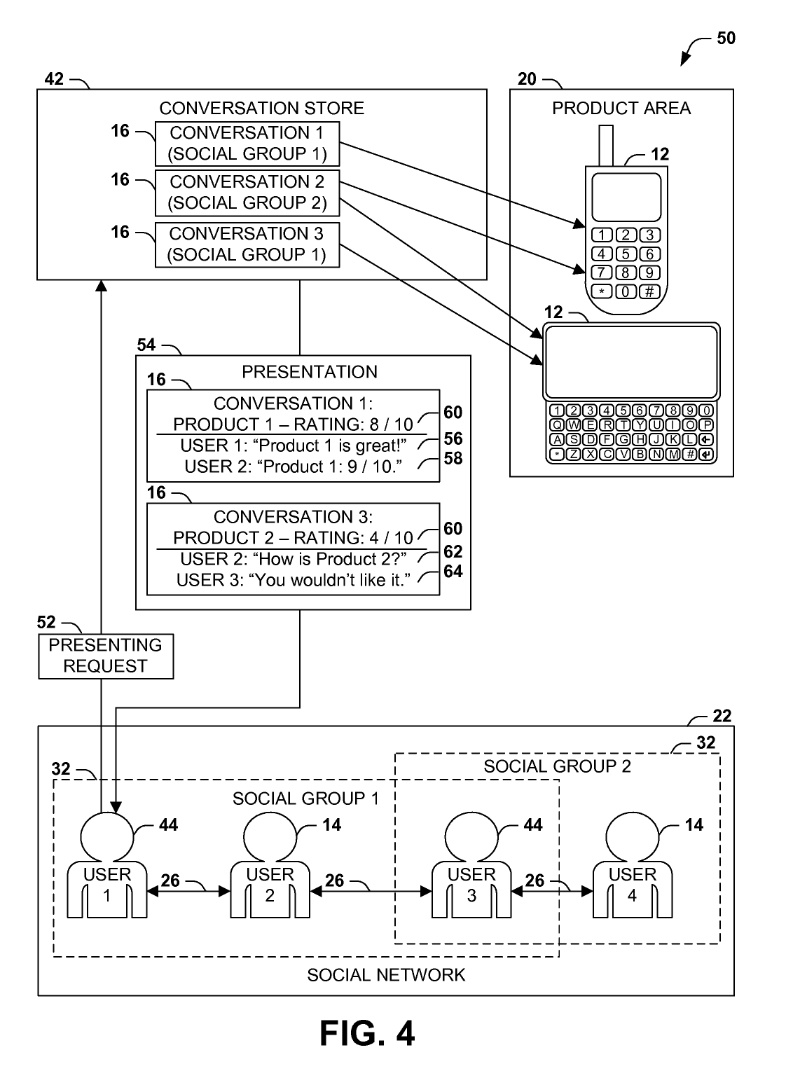

FIGS. 3-4 together illustrate the application of these techniques to hold conversations 16 about products 12 among the users 14 of a social network 22. In the exemplary scenario 40 of FIG. 3, the users 14 of a social network 22 may be organized into social groups 32 according to the associations 26 established thereamong; e.g., a first social group 32 may comprise a second user 14 and a set of associated users 44, including a first user 14 and a third user 14 who have associations 26 with the second user 14. Similarly, a second social group 32 may be identified as a fourth user 14 and an associated user 44 (the third user 14) who has an association 26 with the fourth user 14. The users 14 of these social groups 32 may wish to hold conversations 16 about various products 12 in a product area 20, and the social network 22 may facilitate these conversations 16 through the use of a conversation store 42 configured to store the comments 18 of a conversation 16 about one or more products 20 generated by the users 14 of a particular social group 32. For example, a first conversation 16 may be initiated by the submission by the first user 14 of a comment 18 about the first product 12. Upon receiving the comment 18, the social network 22 may identify that no conversation 16 about the product 12 for the first social group 32 (to which the first user 14 belongs) exists in the conversation store 42, and may therefore initiate a first conversation 16 about the product 12 for the social group 32, and may then store the first comment 18 of the first conversation 16 in the conversation store 42. Upon receiving a second comment 18 about the same product 12 by the second user 14, the social network 22 may store the second comment 14 in the conversation store 42 associated with the first conversation 16. In this manner, the comments 18 submitted by various users 14 of the social network 22 may be stored in the conversation store 42 organized into conversations 16 among the users 14 of a social group 32 about one or more products 12.

FIG. 4 illustrates an exemplary scenario 50 featuring a presentation 54 of the conversations 16 stored in the conversation store 42 about various products 12 to a user 14 of a social group 32. For example, the conversation store 42 holds comments 18 about three conversations 16 relating to the product area 20, including a first conversation 16 and a third conversation 16 among the users 14 of the first social group 32 and a second conversation 16 among the users 14 of the second social group 32. The first user 14 may submit to the social network 22 a presenting request 52 (e.g., a search query specifying “mobile communication devices”) to be presented with conversations 42 relating to the product area 20. The social network 22 may examine the conversation store 42, and may identify that the first user 14 is a member of the first social group 32 but not the second social group 32, and may therefore send to the first user 14 a presentation 54 comprising the first conversation 16 and the third conversation 16, but not the second conversation 16 by the users 14 of a different social group 32. The presentation 54 may include the comments 18 about the products 12 of the product area 20, and may be consolidated into conversations 16. In Moreover, the social network 22 may improve the presentation 54 of the conversations 16, e.g., by consolidating a first comment 18 comprising a user review 56 of the first product 12 (e.g., “Product 1 is great!”) and a second comment 18 comprising a user rating 58 of the first product 12 (e.g., “Product 1 scores 9 out of 10”) into an aggregated user rating 60 for the first product 12, and by presenting the third conversation 16 as a threaded conversation, e.g., as a first comment 18 comprising a user review request 62 for the second product 12 followed by a second comment 18, having a responsive relationship with the first comment 18 and comprising a personalized product review 64 of the second product 12. In this manner, the social network 22 may evaluate a conversation 16 to identify structure, trends, conversation threads, and consensus opinions among the comments 18 thereof, and may adjust the presentation 54 of the conversations 16 to reflect these identified aspects of the conversations 16.

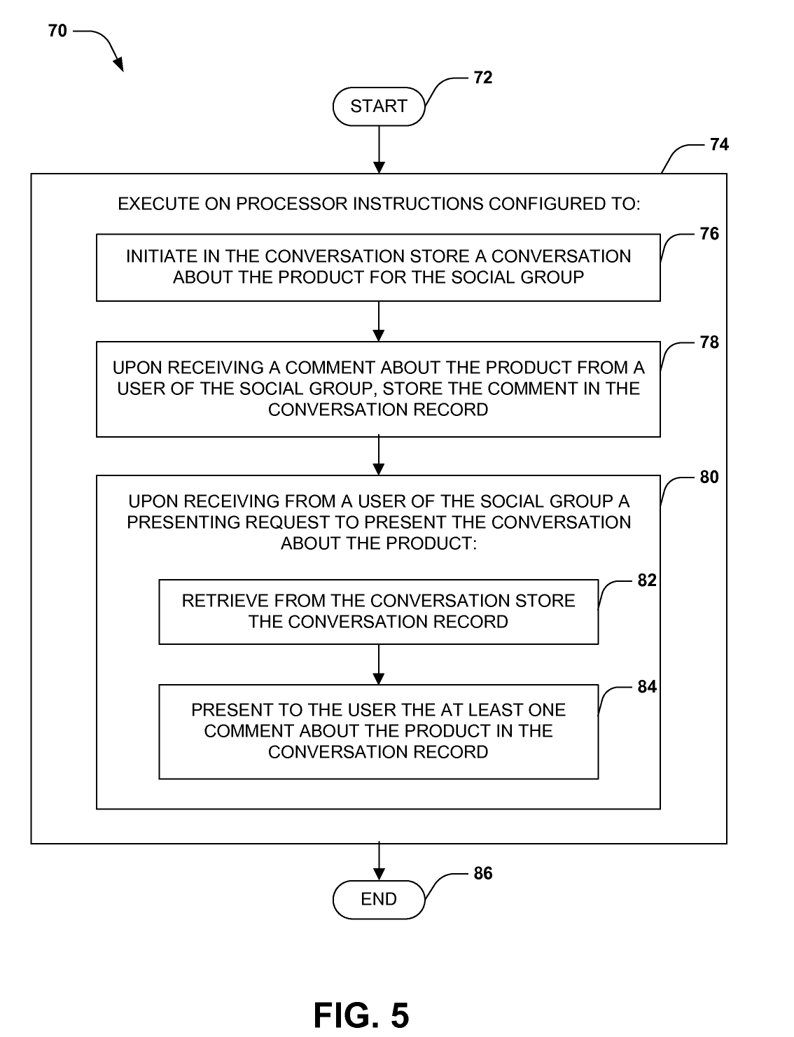

FIG. 5 presents a first embodiment of the techniques presented herein, illustrated as an exemplary method 70 of presenting a conversation 16 about a product 12 among the users 14 of a social group 32. The exemplary method 70 may be implemented as a set of software instructions stored on a volatile or nonvolatile storage component (e.g., system memory, a hard disk drive, a solid state storage device, or an optical or magnetic disc) of a device having a processor and a conversation store 42 configured to store the comments 18 comprising the conversation 16. The exemplary method 70 begins at 72 and involves executing 74 on the processor instructions configured to perform the techniques presented herein. In particular, the instructions are configured to initiate 76 in the conversation store 42 a conversation record about the product 14 for the social group 32. The instructions are also configured to, upon receiving a comment 18 about the product 12 from a user 14 of the social group 32, store 78 the comment 18 in the conversation record. The instructions are also configured to, upon receiving 80 from a user 14 of the social group 32 a presenting request 52 to present the conversation 16 about the product, retrieve 82 from the conversation store 42 the conversation record, and present 84 to the user 14 the at least one comment 18 about the product 12 in the conversation record. In this manner, the exemplary method 70 presents the conversation 18 to the user 14 in accordance with the techniques presented herein, and so ends at 86.

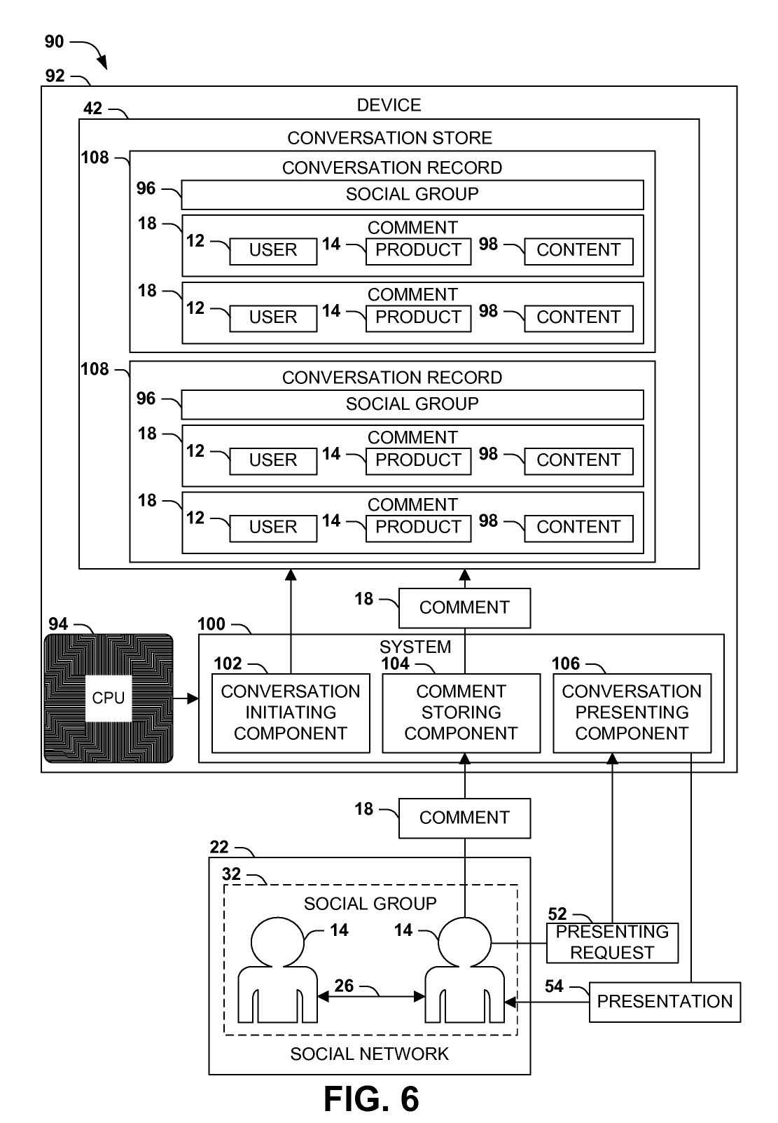

FIG. 6 presents an exemplary scenario 90 featuring a second embodiment of these techniques, illustrated as an exemplary system 100 configured to present a conversation 18 about a product 12 among the users 14 of a social group 32. This exemplary system 100 may be implemented, e.g., as a software architecture comprising a set of software instructions stored on a volatile or nonvolatile storage component (e.g., system memory, a hard disk drive, a solid state storage device, or an optical or magnetic disc) of a device 92 having a processor 94 and a conversation store 42 (which may be stored, e.g., in the same storage component as the software architecture of the exemplary system 100 or in a different storage component.) The device 92 is configured to serve the users 14 of the social group 32, e.g., by receiving comments 18 about various products 12 and presenting request 52 to view conversations 16 about various products 12. The exemplary system 100 comprises a conversation initiating component 102, which is configured to initiate in the conversation store 42 a conversation record 108 about the product 12 for the social group 96. The exemplary system 100 also comprises a comment storing component 104, which is configured to, upon receiving a comment 18 about the product 12 from a user 14 of the social group 32, store the comment 18 in the conversation record 108. The exemplary system 100 also comprises a conversation presenting component 106, which is configured to, upon receiving from a user 14 of the social group 32 a presenting request 52 to present the conversation 16 about the product 12, retrieve from the conversation store 42 the conversation record 108, and present to the user 14 the at least one comment 18 about the product 12 in the conversation record 108. In this manner, the components of the exemplary system 100 store and present to the users 14 of the social group 32 comments 18 comprising conversations 16 about various products 12 according to the techniques presented herein.

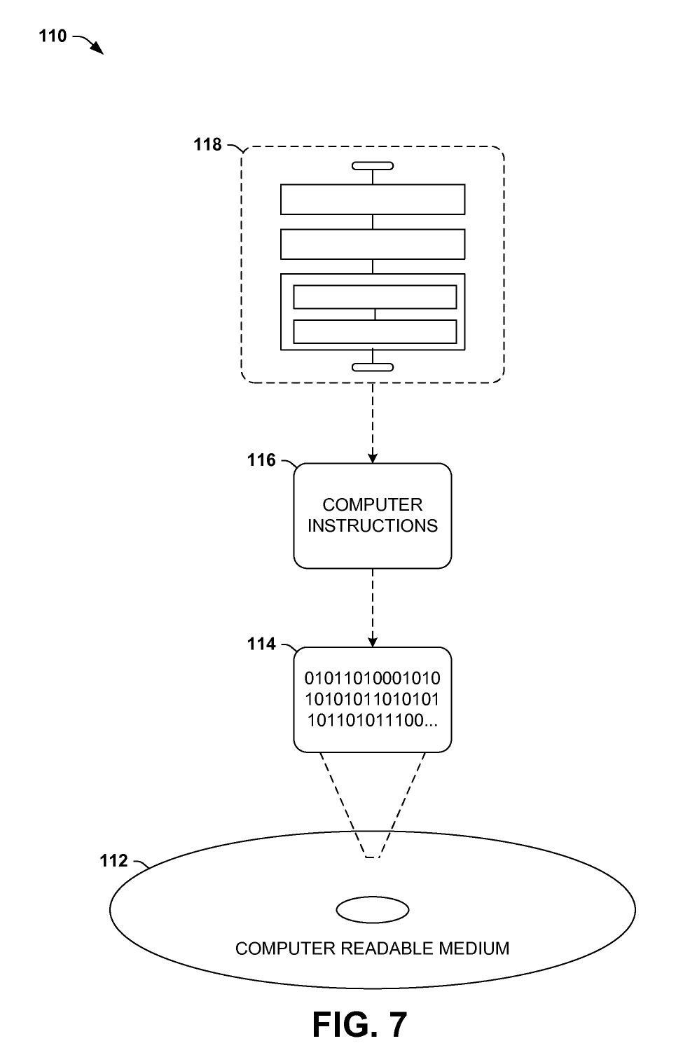

Still another embodiment involves a computer-readable medium comprising processor-executable instructions configured to apply the techniques presented herein. An exemplary computer-readable medium that may be devised in these ways is illustrated in FIG. 7, wherein the implementation 110 comprises a computer-readable medium 112 (e.g., a CD-R, DVD-R, or a platter of a hard disk drive), on which is encoded computer-readable data 114. This computer-readable data 114 in turn comprises a set of computer instructions 116 configured to operate according to the principles set forth herein. In one such embodiment, the processor-executable instructions 116 may be configured to perform a method of presenting a conversation about a product among users of a social group in a social network, such as the exemplary method 70 of FIG. 5. In another such embodiment, the processor-executable instructions 116 may be configured to implement a system for presenting a conversation about a product among users of a social group in a social network, such as the exemplary system 100 of FIG. 6. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 70 of FIG. 5 and the exemplary system 100 of FIG. 6) to confer individual and/or synergistic advantages upon such embodiments.

A first aspect that may vary among embodiments of these techniques relates to the scenarios wherein these techniques may be utilized. As a first example, these techniques may be applied to many types of products 12 within many product areas 20, such as manufactured, cultivated, or discovered articles; media items, such as movies; and tangible services (such as manufacturing or repairing an article) or intangible services (such as teaching a subject.) As a second example of this first aspect, these techniques may be utilized within many types of social networks 22 hosting many types of users 14 and associations 26 thereamong, such as a genealogy social network configured to track families, a friendship social network configured to track friends, an academic or professional social network configured to track scholastic or business contacts, a dating social network configured to perform matchmaking services, and a gaming social network configured to connect users to instances of multiplayer games. As a third example of this first aspect, the comments 18 submitted for various conversations 16 may comprise many types of communication, such as instant messages, chat messages within a chat group, enqueued messages such as email, broadcast messages such as personal status messages, images (such as screenshots or photographs of a product 12), audio or video (such as a personal recording of a user review 56), and/or other data objects (such as hyperlinks referencing sources of information about a product 12.)

As a fourth example of this first aspect, various aspects of these techniques may be extended outside the boundaries of the social network 22. In a first such variation, once the social group 32 is defined among the users 14 of the social network 22, various activities among the users 14 outside of the social network 22 may be relevant to the conversation 16 about the product 12, such as messages 28 or user reviews 56 posted by the users 14 of the social group 32 outside of the social network 22 and commercial activities (such as product purchases) that relate to the product 12 but that are performed through e-commerce websites or brick-and-mortar stores. An embodiment of these techniques may be configured to identify these activities performed outside of the social network 22 and to include them in the conversation 16. One such embodiment may achieve this detection and inclusion, e.g., by associating with a user 14 an indicator of the social groups 32 of the social network 22 to which the user 14 belongs, by detecting the indicator of the user 14 while receiving or monitoring the activities of the user 14 outside of the social network 22, and by annotating the conversation 16 to reflect such activities. (This type of variation may be particularly advantageous, e.g., in scenarios where the user 14 provides a social profile comprising part of the identity of the user 14 in engaging in many types of activities.) This information may be tied together, e.g., with search histories and commercial transactions of various users 14, and this bundle of information may be useful in many ways.

As a second variation of this fourth example of this first aspect, the conversation 16 about one or more products 12 may be presented outside of the social network 22. For example, a product reviews database may have access to the conversations 16 of the social network 22 that relate to particular products 12, and may be configured to extract some or all of the comments 18 regarding a product 12 for inclusion in the information set regarding the product 12 that is stored and provided to various users 12. While it may be undesirable to extract and present such comments 18 without the consent of the users 14 (e.g., for conversations 16 held strictly among the members of the social group 32), but the product reviews database may respect these considerations, e.g., by presenting these comments 18 only to the members of the social group 32 (such as a social search engine that, upon receiving a search query submitted by a user 14 and relating to a product, supplements the search results with comments 18 about the product 12 by the members of the social groups 32 to which the user 14 belongs), by anonymizing the comments 18 comprising the conversation 16, and/or by aggregating the comments 18 into excerpts or summaries that do not identify the users 14. This information may also be presented outside of the social network 22 in many contexts, e.g., to supplement search results for search queries that relate to a product 12, to supplement the information about a product 12 offered by an e-commerce site, or to supplement a database of user reviews 56 of the product 12.

As a third variation of this fourth example of this first aspect, third parties that are not members of the social group 32 may be permitted to participate in the conversation 16 in particular ways. For example, a non-member of a social group 32 (such as a product vendor, an independent product review group, a member of another social group 32, or a member of the public) may submit to the social group 32 a request for the social group 32 to discuss a particular product 12; may monitor part or all of the conversation 16 (e.g., by viewing each comment 18 of the conversation 16 or only a summary of the conversation 16, such as an excerpt or aggregated product rating of the product 12); and/or may be permitted to submit comments 18 to the conversation 16. In some such embodiments, the conversation 16 may be supplemented with user reviews 56 submitted outside of the social group 32 and the social network 22, and/or may be merged with other conversations 16 about the product 12 among the members of other social groups 32. In this manner, the conversations 16 and activities by the users 14 of the social group 32 may be related to a particular product 12 in contexts outside of the social network 22, and, conversely, non-members of the social group 32 may be exposed to and may participate in the conversation 16 among the members of the social group 32. Those of ordinary skill in the art may envision many scenarios wherein the techniques presented herein may be utilized.

A second aspect that may vary among embodiments of these techniques relates to the architecture of the embodiment. As a first example, while FIG. 5 illustrates one exemplary method 70 embodying the techniques presented herein, other methods may embody the techniques through a different number or combination of elements; e.g., the initiating 76 of the conversation 16 may occur after receiving a comment 18 and determining that no conversation 16 in the conversation store 42 exists about the product(s) 12 discussed in the comment 18 for any social group 32 including the user 14 who submitted the comment 18. As a second example, while FIG. 6 illustrates one exemplary system 100 embodying the techniques presented herein, other systems may embody the techniques through a different number or combination of elements; e.g., the conversation component 106 might be implemented as a first component having read-only access to the conversation store 42 (while performing fewer security checks on the presenting request 52), while the conversation initiating component 102 and the comment storing component 104 may be implemented as a second component having read/write access to the conversation store 42 (but with heightened security checks that diminish performance but that improve the security of the conversation store 42.) Those of ordinary skill in the art may devise many architectures while designing embodiments of the techniques presented herein.

A third aspect that may vary among embodiments of these techniques relates to the manner of identifying a social group 32 among the users 14 of a social network 22. As a first example, the social group 32 for a particular conversation 16 may be identified as the set of users 14 comprising the user 14 who initiated the conversation 42 (e.g., a user 14 who submitting a comment 18 regarding a product 12 or product area 20 when no such conversation 16 about the product 12 or product area 20 exists for the social group 32) and all of the users 14 who have an association 26 with the user 14. As a second example of this third aspect, the social group 32 for a particular conversation 16 may comprise a highly interconnected set of users 14, where each user 14 as an association 26 with many of the other users 14 of the social group 32. This social group 32 may be automatically identified, and may comprise the members of a family, a social clique, the students in a class in an academic setting, or the members of a group or department within an organization. As a third example of this third aspect, the social group 32 for a particular conversation 16 may comprise a set of users 14 who share one or more traits (as may be indicated, e.g., by the social profiles 24 of the users 14), such as users 14 who live in a particular geographic region and who share an interest in a particular activity, such as the sport of tennis. As a fourth example of this third aspect, the social group 32 for a particular conversation 16 may be explicitly defined by the users 14, e.g., by self-selection as a member of a social group 32. Some social networks 22 may also permit users 14 of the social group 32 (such as administrators of the social group 32) to add other users 14 to the social group 32 and/or to remove other users 14 from the social group. In particular, it may be advantageous include in the social group 32 an advisor or expert in the product area 20, or a vendor representative of a vendor of a product 12 included in the conversation 16. Moreover, in some such embodiments, it may be possible for the vendor representative to interact with the users 14 of the conversation 16 regarding a product 12 of the vendor in other ways, e.g., by presenting to the users 14 of the social group 32 of the conversation 16 an offer regarding the product 12 discussed in the conversation 16. Those of ordinary skill in the art may devise many types of social groups 32 and the identification thereof while implementing the techniques presented herein.

A fourth aspect that may vary among embodiments of these techniques relates to the manner of initiating 76 the conversation 16 about one or more products 12 or a product area 20 for the users 14 of a social group 32. As a first example, the conversation 16 may be initiated upon receiving from a user 14 of a social group 32 a comment 18 regarding a product 12, such as a user review request 62 for the product 12 (e.g., “can anyone tell me what this product is like?”), a user review 56 about the product 12 (e.g., “I just bought this product, and here's what I think of it . . . ”), or a user rating 58 (e.g., “I give this product three stars out of five”), when no such conversation 16 has previously been initiated. In accordance with this first example, upon receiving a comment 18 from a user 14 about the product 12, an embodiment may first determine whether a conversation record 108 about the product 12 for any social group 32 including the user 14 exists in the conversation store 42; and if not, the embodiment may initiate in the conversation store 42 a conversation record 108 about the product 12 for at least one social group 32 including the user 14. As a second example of this fourth aspect, the conversation 16 may be initiated upon receiving from a user 14 a comment 18 about a product area 20, such as a product recommendation request (e.g., “can someone recommend a product for me in this product area?”), a product recommendation of a product 12 in a product area 20 (e.g., “among all of the products in this product area, this product has the highest quality”), or a comparison of two or more products 12 in a product area 20, when no conversation 16 about the product area 20 exists in the conversation store 42. For example, upon receiving an initiating request from a user 14 of the social group 20 for a product recommendation of a product 12 in the product area 20, an embodiment may be configured to determine whether a conversation record 108 about the product area 20 for any social group 32 including the user 14 exists in the conversation store 42, and if not, initiating in the conversation store 42 a conversation record 108 about the product area 20 for the social group 32 of the user 14.

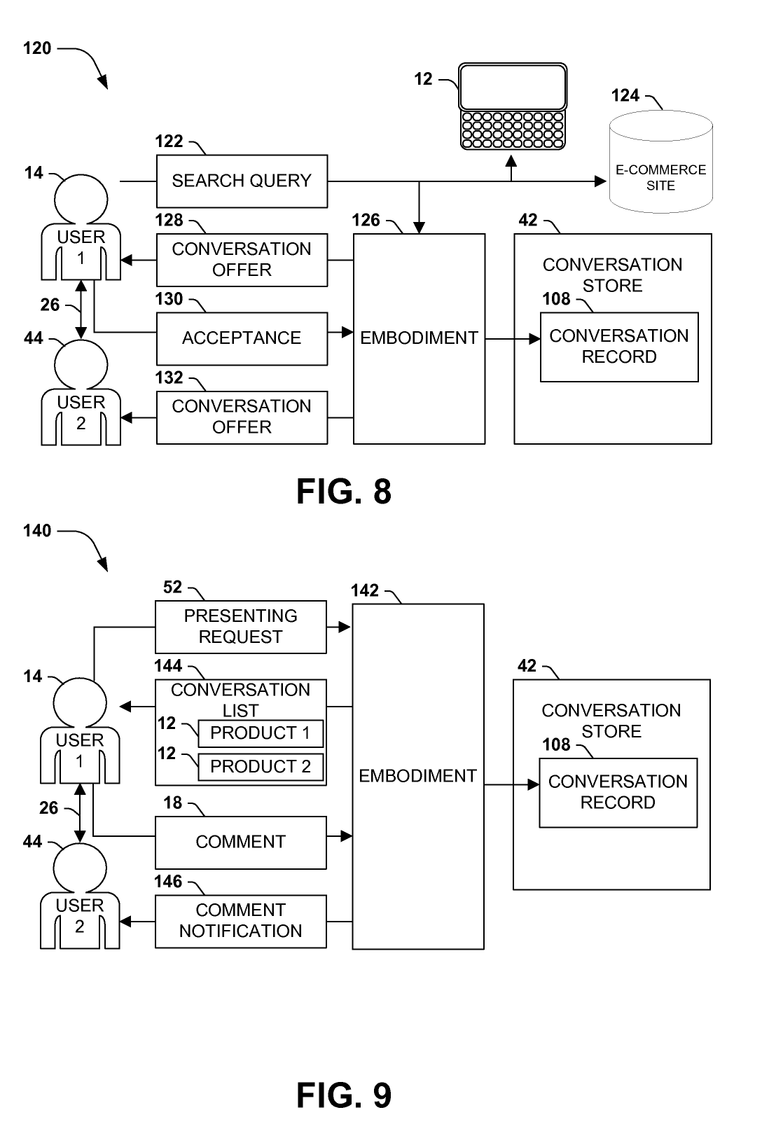

FIG. 8 presents an illustration of an exemplary scenario 120 featuring a third example of this fourth aspect, wherein a conversation 16 about a product 12 is initiated in response to a search query 122 from a user 14 about the product 12, when no such conversation 16 exists for any social group 32 including the user 14. Upon receiving from the user 14 a search query 122 to be applied to a content set (such as a web search to be applied to an index of web resources, such as the web pages of various websites, or the name of a product 12 to be applied to an e-commerce site), it may be possible for an embodiment 126 of these techniques to identify one or more products 12 or product areas 20 referenced in the search query (e.g., through the inclusion of keywords, identifiers such as product names, or uniform resource identifiers (URIs) that reference the locations of web resources associated with a product 12 or product area 20.) In this exemplary scenario 120, a user 14 of the social network 32 submits a search query 122 for a product 12 to an e-commerce site 124, indicating a potential interest of the user 14 in purchasing the product 12. Upon receiving this search query 122, the embodiment 126 may identify the name of the product 12 in the search query 122, and may detect that the user 14 is interested in the product 12. The embodiment 126 may then search the conversation store 42 for a conversation record 108 for a conversation 16 relating to the product 12 among a social group 32 of the user 14. Upon failing to identify such a conversation record 108, the embodiment 126 may send to the user 14 a conversation offer 128 to initiate a conversation 16 about the product 12; and upon receiving from the user 14 an acceptance 130 of the conversation offer 128, the embodiment 126 may initiate a conversation record 108 in the conversation store 42 about the product 12 for a social group 32 including the user 14. Additionally, upon initiating a conversation 16 about a product 12 or product area 20 in the conversation store 42, an embodiment 142 may identify one or more associated users 44 of the social network 32 who have an association 26 with the user 14, and may send to such associated users 44 a conversation offer 132 to invite the associated user 44 to participate in the new conversation 16 (e.g., “your friend is considering purchasing product 1; discuss this product here!”) In this manner, the embodiment 126 may facilitate the conversation 16 about the product 12 among the users 14 of the social group 32 in the social network 22.

As a fourth example of this fourth aspect, a conversation 16 may be initiated about a product area 20, but may also specify one or more product area criteria that limit the products 12 that may be discussed in the conversation 16, such as a geographic criterion (e.g., restaurants within a particular area) or a price criterion (e.g., products 12 within a certain price range.) An embodiment of these techniques may store the one or more product area criteria in the conversation record 108 of the conversation 16. Moreover, an embodiment may be configured to accept comments 18 from users 14 of the social group 32 only if such comments 18 relate to a product 12 fulfilling the at least one product area criterion, and may simply reject comments 18 about products 12 that do not fulfill this product area criterion. In this manner, the conversation 18 may be filtered to selected products 12 meeting limitations desired by the users 14. Those of ordinary skill in the art may devise many ways of initiating 76 conversations 16 about various products 12 and product areas 20 within social groups 32 of a social network 22 while implementing the techniques presented herein.

A fifth aspect that may vary among embodiments of these techniques relates to the manner of storing 78 a comment 18 in the conversation record 108 of a conversation 16. As a first example, where the conversation 16 relates to a product area 20 limited by at least one product area criterion, the embodiment may evaluate a received comment 18 to verify that it relates to a product 12 satisfying the at least one product area criterion associated with the conversation 16; if so, the embodiment may store the comment 18, but if not, the embodiment may reject the comment 18. As a second example of this fifth aspect, upon storing a comment 18 of a conversation 16 for a social group 32, an embodiment may be configured to notify at least one other user 14 of the social group 32 regarding the comment 18 about the product 12. Those of ordinary skill in the art may devise many ways of storing comments 18 associated with respective conversations 16 about various products 12 for a social group 32 while implementing the techniques presented herein.

A sixth aspect that may vary among embodiments of these techniques relates to the manner of presenting 80 one or more conversations 16 in response to a presenting request 52 received from a user 14 of the social group 32. As a first example, when a user 14 of a social group 32 submits a presenting request 52 about a product area 20, an embodiment of these techniques may examine the conversation store 42 to identify the conversations 16 about the product area 20 for the social groups 32 of the user 14 (e.g., conversations about the product area 20 in general, or about one or more products 12 in the product area 20.) The embodiment may then present to the user 14 a conversation list that indicates the existing conversations 16 about the product area 20, and the user 14 may select a conversation 16 in the conversation list to view the comments 18 relating thereto. Similarly, a particular product 12 may be the subject of several conversations 16 (e.g., a first conversation 16 about the product 12, a second conversation 16 comparing the product 12 to another product 12 in the product area 20, and a third conversation 16 about all products 12 in the product area 20 that mentions the particular product 12.) This circumstance may also arise, e.g., where a user 14 is a member of at least two social groups 32, each of which has initiated a conversation 16 about the product 12. Therefore, when a user 14 submits a presenting request 52 for conversations 16 about a product 12, an embodiment may identify several conversations 16 about the product 12 in the conversation store 42 for the social groups 32 to which the user 14 belongs, and may also present the comments 18 of each conversation 16 (e.g., upon receiving a user selection by the user 14 of one conversation 16, or by presenting all comments 18 of all conversations 16 in a threaded manner.)

FIG. 9 presents an illustration of an exemplary scenario 140 featuring several of these variations, where a first user 14 submits to an embodiment 142 of these techniques a presenting request 52 for conversations 16 about a product area 20. The embodiment 142 may search the conversation store 42 for one or more conversation records 108 about products 12 in the product area 20, and may identify two conversations 16 relating to two such products 12. The embodiment 142 may then present to the first user 14 a conversation list 144 indicating the conversations 16 about the products 12, and the first user 14 may select a conversation 16 to view the comments 18 in the selected conversation 16 about the product 12. Moreover, when the first user 14 submits a comment 18 to be added to one of the conversations 16, the embodiment 142 may send to an associated user 44 in the social group 32 who has an association with the first user 14 a comment notification 146 of the comment 18 submitted by the first user 14. In this manner, the embodiment 142 may facilitate the conversations 16 about the products 12 among the users 14 of the social group 32.

As a second example of this sixth aspect, an embodiment may, upon generating a presentation 54 of a conversation 16 for delivery to a user 14, identify a trend or consensus of the comments 18 of the conversation 16, and may attempt to present a summary or conclusion of the conversation 16 along with the comments 18 in the presentation 54. For example, if several comments 18 in the conversation 16 comprise user reviews 56 of the product 12, the presentation 54 may select one or more of the user reviews 56 (e.g., a user review 56 selected as persuasive by several users 14 in the social group 32) as representative of the product 12, or may attempt to summarize the user reviews 56. Additionally, if one or more comments 18 comprise a user rating 58 of the product 12, an embodiment may compute an aggregated user rating 60 (e.g., as an arithmetic mean, median, or mode among the user reviews 58) for inclusion in the presentation 54. Similarly, if the comments 18 of a conversation 16 appear to reach a consensus view (e.g., with many users 14 agreeing on a recommendation of a product 12 in a product area 20), the consensus view may be included in the presentation 54.

As a third example of this sixth aspect, some comments 18 of the conversation 16 may be identified as responsive to other comments 18 of the conversation 16. For example, a conversation 16 relating a product 12 may involve two comments 18 comprising user reviews 56 of the product 12, but one user review 56 may have been written in response to another user review 56 (e.g., supplementing missing information from the first user review 56 or debating some of the aspects of the first user review 56.) In these and other scenarios, an embodiment of these techniques may identify that at least one second comment 18 in the conversation record 108 has a responsive relationship with a first comment 18 in the conversation record 108, and may present the conversation record 108 as at least one conversation thread comprising the first comment 18 followed by the second comment 18. For example, the conversation 16 may be presented as a tree view, with respective comments 18 presented as nodes of the tree, and where any second comment 18 having a responsive relationship with a first comment 18 is presented as a child node of the node of the first comment 18.

As a fourth example of this sixth aspect, one or more comments 18 of a conversation 16 may indicate a consumer action taken by the author of the comment 18 regarding a product 12 involved in the conversation 16, such as a purchase of the product 12, a sale of the product 12 to another user 14, a use of the product 12 such as a demonstrational use, or a disposal or return of the product 12. These consumer actions may render such comments 18 particularly relevant within the conversation 16, and an embodiment of these techniques may identify the consumer actions associated with respective comments 18 and may, e.g., highlight such comments 18 in the conversation 16. For example, where an action comment in the conversation record 108 of a conversation 16 indicates at least one consumer action taken by the user 14 authoring the action comment regarding at least one product 14, the at least one consumer action taken regarding the product 12 may be presented (e.g., a presentation 54 of a conversation 16 regarding a product 12 may indicate how many users 14 of the social group 32 of the conversation 16 have purchased the product 12.)

As an additional variation of this fourth example of this sixth aspect, some consumer actions may have been taken in response to the comments 18 of another user 14 in the conversation 16; e.g., a first user 14 may purchase a product 12 after receiving a product recommendation of the product 12 from a second user 14. An embodiment of these techniques may, while evaluating the conversation 16, detect both the consumer action of the first user 14 indicated in a first comment 18 and a preceding comment 18 by a second user 14 to which the first comment 18 was responsive, thereby indicating a potential influence of the preceding comment 18 and the second user 14 upon the first user 14. This identification of influence may be useful in many ways, e.g., to indicate a particularly influential user review 56 of the product 12 or to track the influence of a particular user 14 as a measure of the persuasiveness of the user 14 or the expertise of the user 14 in a particular product area 20. The embodiment may also notify the second user 14 of the influence of the second comment 18; e.g., where an action comment has a responsive relationship with a first comment 18 by a first user 14 and indicates a consumer action by the user 14 authoring the action comment that was taken in response to the first comment 16, an embodiment may be configured to notify the first user 14 of the consumer action taken by the user 14 authoring the action comment in response to the first comment 18.

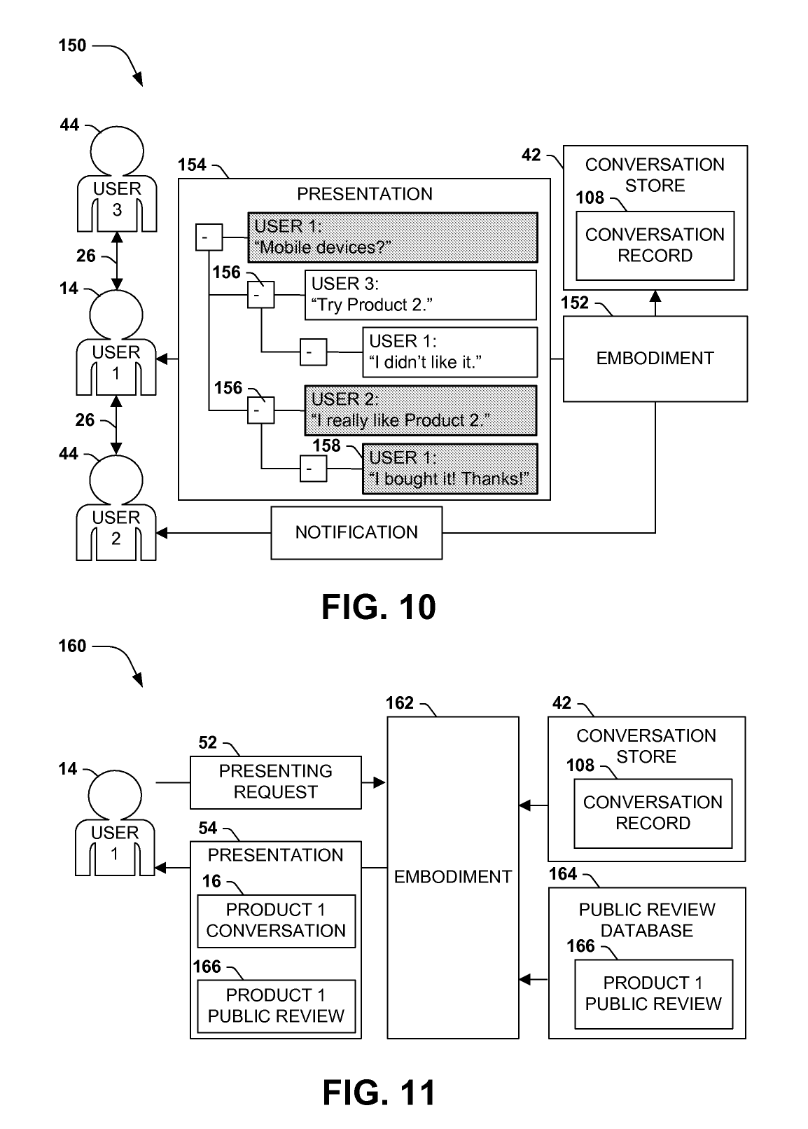

FIG. 10 presents an exemplary scenario 150 presenting some of these variations of this sixth aspect. In this exemplary scenario 150, a first user 14 initiates with several associated users 44 of a social group 32 a conversation 16 regarding a product area 20, and an embodiment 152 of these techniques initiates in the conversation store 42 a conversation record 108 regarding the product area 20. The conversation 16 may involve several comments 18 of various types (e.g., the initial comment 18 may comprise a product recommendation request for a product 12 in the product area 20, which may prompt other comments 18 comprising product recommendations 156.) Accordingly, the embodiment 152 may present a threaded view 154 of the conversation 16, such as a treeview arrangement of comments 18 that illustrates the responsive relationships thereamong. The embodiment 152 also identifies significant comments 18 within the conversation 16 and may draw attention to these comments 18, e.g., by shading or prioritizing in the threaded view 154 the comments 156 that reflect the current state of the conversation 16. For example, the embodiment 152 may identify a particular comment 18 comprising a consumer action, such as a purchase by a user 14 of the product 12, and may highlight this action comment 158 as an indication of significance within the conversation 16. The embodiment 152 may also detect that the action comment 158 is responsive to a preceding comment 18 by the second user 14, and may notify the second user 14 of the action comment 158 (e.g., “User 1 purchased the product based on your recommendation.”) In this manner, the embodiment 152 may generate and deliver an improved presentation of the conversation 16 based on some of these variations of this sixth aspect.

As a fifth example of this sixth aspect, the presentation 54 of a conversation 16 may include, along with the comments 18 of the conversation 16 that are personalized for the users 14 of the social group 32 (such as personalized product reviews 64), one or more public information items that are not particular to or personalized for the social group 32. This information may be used to supplement the conversation 16 either upon request of a user 14 of the social group 32, or automatically (e.g., upon initiating a conversation 16 regarding a product 12, or upon receiving a comment 18 about a product 12 to be added to a conversation 16, an embodiment may retrieve a public review of the product 12 from a product review database to be included in presentations 54 of the conversation 16.) This variation may be advantageous, e.g., for supplementing the conversation 16 with information about products 12 from expert sources that may be more informed or reliable than the users 14 of the social group 32, or by providing information about a product 12 that the users 14 of the social group 32 have not utilized, or about which the users 14 of the conversation 16 have not yet contributed a comment 18.

FIG. 11 presents one variation of this fifth example, wherein an embodiment 162 of these techniques may receive from a user 14 of a social group 32 a presenting request 52 to present a conversation 20 represented as a conversation record 108 within a conversation store 42. The embodiment 162 may satisfy this request by generating a presentation 54 including the comments 18 comprising the conversation 16 about the product 12. Additionally, the embodiment 162 may retrieve a public review 166 of the product 12 from a public review database 164, and may include the public review 166 of the product 12 in the presentation 54. In this manner, the embodiment 162 may supplement the presentation 54 of the conversation 16 with additional information. Those of ordinary skill in the art may devise many ways of presenting 54 the conversation 16 of one or more products 12 or product areas 20 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

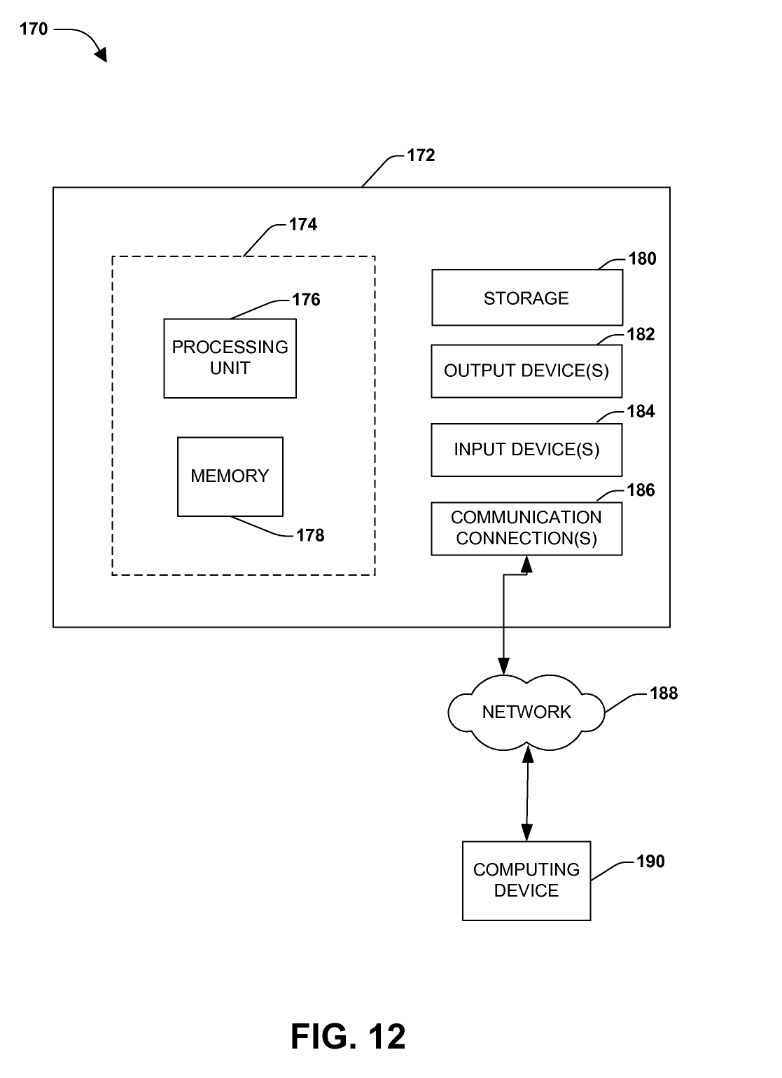

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 170 comprising a computing device 172 configured to implement one or more embodiments provided herein. In one configuration, computing device 172 includes at least one processing unit 176 and memory 178. Depending on the exact configuration and type of computing device, memory 178 may be volatile (such as RAM, for example), non-volatile (such as ROM, flash memory, etc., for example) or some combination of the two. This configuration is illustrated in FIG. 12 by dashed line 174.

In other embodiments, device 172 may include additional features and/or functionality. For example, device 172 may also include additional storage (e.g., removable and/or non-removable) including, but not limited to, magnetic storage, optical storage, and the like. Such additional storage is illustrated in FIG. 12 by storage 180. In one embodiment, computer readable instructions to implement one or more embodiments provided herein may be in storage 180. Storage 180 may also store other computer readable instructions to implement an operating system, an application program, and the like. Computer readable instructions may be loaded in memory 178 for execution by processing unit 176, for example.

The term “computer readable media” as used herein includes computer storage media. Computer storage media includes volatile and nonvolatile, removable and non-removable media implemented in any method or technology for storage of information such as computer readable instructions or other data. Memory 178 and storage 180 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 172. Any such computer storage media may be part of device 172.

Device 172 may also include communication connection(s) 186 that allows device 172 to communicate with other devices. Communication connection(s) 186 may include, but is not limited to, a modem, a Network Interface Card (NIC), an integrated network interface, a radio frequency transmitter/receiver, an infrared port, a USB connection, or other interfaces for connecting computing device 172 to other computing devices. Communication connection(s) 186 may include a wired connection or a wireless connection. Communication connection(s) 186 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 172 may include input device(s) 184 such as keyboard, mouse, pen, voice input device, touch input device, infrared cameras, video input devices, and/or any other input device. Output device(s) 182 such as one or more displays, speakers, printers, and/or any other output device may also be included in device 172. Input device(s) 184 and output device(s) 182 may be connected to device 172 via a wired connection, wireless connection, or any combination thereof. In one embodiment, an input device or an output device from another computing device may be used as input device(s) 184 or output device(s) 182 for computing device 172.

Components of computing device 172 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 172 may be interconnected by a network. For example, memory 178 may be comprised of multiple physical memory units located in different physical locations interconnected by a network.

Those skilled in the art will realize that storage devices utilized to store computer readable instructions may be distributed across a network. For example, a computing device 190 accessible via network 188 may store computer readable instructions to implement one or more embodiments provided herein. Computing device 172 may access computing device 190 and download a part or all of the computer readable instructions for execution. Alternatively, computing device 172 may download pieces of the computer readable instructions, as needed, or some instructions may be executed at computing device 172 and some at computing device 190.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting a conversation about a product among users of a social group on a device having a processor and a conversation store, the method comprising:
executing on the processor instructions configured to:
initiate in the conversation store a conversation record about the product for the social group;
upon receiving a comment about the product from a user of the social group, store the comment in the conversation record; and
upon receiving from a user of the social group a presenting request to present the conversation about the product:
retrieve from the conversation store the conversation record, and
present to the user the at least one comment about the product in the conversation record.

2. The method of claim 1, the social group comprising:
an initiating user submitting an initiating request to initiate the conversation record about the product for the social group in the conversation store, and
at least one associated user having an association with the initiating user.

3. The method of claim 2, the social group comprising at least one vendor representative of at least one vendor of at least one product included in the conversation.

4. The method of claim 3, the instructions configured to, upon receiving from a vendor representative of a vendor an offer regarding a product of the vendor, presenting the offer to the users of the social group.

5. The method of claim 1, initiating the conversation record about the product for the social group comprising:
upon receiving from a user a search query about a product:
determining whether a conversation record about the product for a social group including the user exists in the conversation store;
upon determining that a conversation record about the product for a social group including the user exists in the conversation store, presenting to the user the at least one comment about the product for the social group in the conversation record; and
upon determining that a conversation record about the product for a social group including the user does not exist in the conversation store:
presenting to the user an offer to initiate a conversation about the product for the social group in the conversation store; and
upon receiving from the user an acceptance of the offer, initiating in the conversation store the conversation record about the product for the social group.

6. The method of claim 1, initiating the conversation record about the product for the social group comprising:
upon receiving a comment from a user of the social group about the product:
determining whether a conversation record about the product for a social group including the user exists in the conversation store; and
upon determining that a conversation record about the product for a social group including the user does not exist in the conversation store, initiating in the conversation store the conversation record about the product for the social group.

7. The method of claim 1, the instructions configured to, upon initiating the conversation record about the product for the social group in the conversation store, invite at least one user of the social group to submit a comment about the product.

8. The method of claim 1, the conversation regarding a product area comprising at least two products.

9. The method of claim 8, initiating the conversation record about the product area for the social group comprising:
upon receiving an initiating request from a user of the social group for a product recommendation of a product in the product area:
determine whether a conversation record about the product area for a social group including the user exists in the conversation store; and
upon determining that a conversation record about the product area for a social group including the user does not exist in the conversation store, initiating in the conversation store the conversation record about the product area for the social group.

10. The method of claim 8:
the product area having at least one product area criterion; and
storing a comment about a product in the conversation record comprising:
determining whether the product of the comment meets the at least one product area criterion; and
upon determining that the product of the comment meets the at least one product area criterion, storing the comment about the product for the social group in the conversation record.

11. The method of claim 8, presenting to the user the at least one comment about the product in the conversation record comprising:
presenting to the user a conversation list comprising conversations having at least one comment about the product for a social group including the user in the conversation record; and
for respective conversations in the conversation list, presenting the comments of the conversation about the product for the respective social group including the user in the conversation record.

12. The method of claim 8, presenting the at least one comment about the product in the conversation record comprising:
selecting at least one recommended product having at least one positive recommendation among the comments in the conversation record for a social group including the user; and
presenting to the user a product recommendation of the at least one recommended product.

13. The method of claim 1:
at least one comment about the product in the conversation record comprising at least one user rating; and
presenting the at least one comment about the product in the conversation record comprising:
aggregating the user ratings of the product in the comments of the conversation record for a social group including the user to compute an aggregated user rating, and
presenting the aggregated user rating with the at least one comment about the product.

14. The method of claim 1, the instructions configured to, upon receiving from a user of the social group a comment about the product, notify at least one other user of the social group regarding the comment about the product.

15. The method of claim 1:
at least one second comment in the conversation record having a responsive relationship with a first comment in the conversation record; and
presenting the at least one comment about the product in the conversation record comprising: presenting the conversation record as at least one conversation thread comprising the first comment and the second comment.

16. The method of claim 1:
at least one action comment in the conversation record indicating at least one consumer action taken by the user authoring the action comment regarding at least one product; and
presenting the at least one comment about the product in the conversation record comprising: presenting the at least one consumer action taken regarding the product.

17. The method of claim 16:
at least one action comment having a responsive relationship with a first comment by a first user, the action comment indicating a consumer action by the user authoring the action comment taken in response to the first comment; and
the instructions configured to, upon receiving the action comment, notify the first user of the consumer action taken by the user authoring the action comment in response to the first comment.

18. The method of claim 1, presenting the at least one comment about the product in the conversation record comprising:
retrieving at least one public review of at least one product having at least one comment in the conversation record, and
presenting to the user the at least one public review of the at least one product.

19. A system configured to present a conversation about a product among users of a social group on a device having a conversation store, the system comprising:
a conversation initiating component configured to initiate in the conversation store a conversation record about the product for the social group;
a comment storing component configured to, upon receiving a comment about the product from a user of the social group, store the comment in the conversation record; and
a conversation presenting component configured to, upon receiving from a user of the social group a presenting request to present the conversation about the product:
retrieve from the conversation store the conversation record, and
present to the user the at least one comment about the product in the conversation record.

20. A computer-readable storage medium comprising instructions that, when executed by a processor of a device having a conversation store, present a conversation about a product among users of a social group comprising an initiating user submitting an initiating request to initiate the conversation record about the product for the social group in the conversation store and at least one associated user having an association with the initiating user by:
upon receiving from a user a search query about a product:
determining whether a conversation record about the product for a social group including the user exists in the conversation store;
upon determining that a conversation record about the product for a social group including the user exists in the conversation store, presenting to the user the at least one comment about the product in the conversation record; and
upon determining that a conversation record about the product for a social group including the user does not exist in the conversation store:
presenting to the user an offer to initiate a conversation about the product for the social group in the conversation store; and
upon receiving from the user an acceptance of the offer:
initiating in the conversation store the conversation record about the product for the social group, and
inviting at least one user of the social group to submit a comment about the product;
upon receiving an initiating request from a user of the social group for a product recommendation of a product in the product area:
determine whether a conversation record about the product area for a social group including the user exists in the conversation store; and
upon determining that a conversation record about the product area for a social group including the user does not exist in the conversation store:
initiating in the conversation store the conversation record about the product area for the social group, and
inviting at least one user of the social group to submit a comment about at least one product in the product area;
upon receiving a comment from a user of the social group about the product:
determining whether a conversation record about the product for a social group including the user exists in the conversation store;
upon determining that a conversation record about the product for a social group including the user does not exist in the conversation store:
initiating in the conversation store the conversation record about the product for the social group, and
inviting at least one user of the social group to submit a comment about the product;
store the comment in the conversation record; and
notify at least one other user of the social group regarding the comment about the product;
upon receiving from a user of the social group a presenting request to present the conversation about the product:
retrieving from the conversation store the conversation record;
retrieving at least one public review of at least one product having at least one comment in the conversation record, and
presenting to the user the at least one comment about the product in the conversation record and the at least one public review of the at least one product.
